(19) United States
(12) Patent Application Publication
(10) Pub. No.: US 2024/0199419 A1
(43) Pub. Date: Jun. 20, 2024

(54) METHOD AND SYSTEM FOR NANOMATERIAL PRODUCTION

(71) Applicant: Fortum Battery Recycling Oy, Harjavalta (FI)

(72) Inventors: Jorma Jokiniemi, Vantaa (FI); Tommi Karhunen, Kuopio (FI); Anna Lähde, Toivala (FI)

(73) Assignee: Fortum Battery Recycling Oy, Harjavalta (FI)

(21) Appl. No.: 18/287,224

(22) PCT Filed: Apr. 19, 2021
(86) PCT No.: PCT/FI2021/050282

§ 371 Date: Oct. 17, 2023

(51) Int. Cl. C01B 13/34; B82Y 40/00; C01G 23/00; F01K 3/26

(52) U.S. Cl. CPC C01B 13/34; B82Y 40/00; C01G 23/005; F01K 3/262

(57) ABSTRACT

The invention is concerned with a method for combined production of nanomaterials and heat. The method comprises feeding at least one precursor material and a fuel into a combustion unit for the generation of heat and nanoparticles, whereby the precursor material is combusted to be decomposed and oxidized in a sufficient temperature. The heat generated in the combustion of the fuel and the precursor material is recovered by using at least one heat exchanger. The combusted fuel is cooled down and the nanoparticles generated in the form of oxides in the combustion are collected. The system of the invention for combined production of nanomaterials and heat comprises a combustion unit, means for feeding at least one precursor material, fuel and oxidizer into the combustion unit for combustion, a heat exchanger for recovering heat from the combustion unit, and for cooling the combusted fuel, and means for collecting nanomaterials in the form of oxides from the combustion of the precursor material(s).

### TECHNICAL FIELD

The invention is concerned with a method and system for nanoparticle production.

### BACKGROUND

Nanomaterials and/or nanoparticles are between 1 and 100 nanometers in size and they are used in a broad spectrum of applications such as in e.g. manufacturing of materials, in energy and in electronics. Most applications require a precisely defined, narrow range of particle sizes (monodispersity).

Specific synthesis processes are employed to produce the various nanoparticles, in the form of powders, coatings, dispersions or composites. Defined production and reaction conditions are crucial in obtaining such size-dependent particle features.

Two basic strategies are used to produce nanoparticles, which often are called ‘top-down’ and ‘bottom-up’ processes. The term ‘top-down’ refers here to the mechanical crushing of source material using a milling process. In the ‘bottom-up’ strategy, structures are built up by chemical processes. The selection of the respective process depends on the chemical composition and the desired features specified for the nanoparticles.

Bottom-up methods are based on physicochemical principles of molecular or atomic self-organization for producing more complex structures from atoms or molecules, better controlling sizes, shapes and size ranges. It includes gas phase processes, also called aerosol processes, precipitation reactions and solgel processes.

Gas phase processes, i.e. aerosol processes, are among the most common industrial-scale technologies for producing nanomaterials in powder or film form. Such an aerosol technology covers methods, in which small particles are produced in gas phase. In this technology, nanoparticles are tailored for both size and composition by forming particles in a gas phase environment.

The nanoparticles are created from the gas phase by producing a vapor of the product material using chemical or physical means. The production of the initial nanoparticles, which can be in a liquid or solid state, takes place via homogeneous nucleation.

Depending on the process, further particle growth involves condensation (transition from gaseous into liquid aggregate state), chemical reaction(s) on the particle surface and/or coagulation processes (adhesion of two or more particles), as well as coalescence processes (particle fusion). Examples of further particle growth processes include processes in flame-, plasma-, laser- and hot wall reactors, yielding products such as fullerenes and carbon nanotubes:

In flame reactors, nanoparticles are formed by the decomposition of source molecules in a flame of e.g. ethanol or hydrogen at relatively high temperatures. Flame reactors are used today e.g. for the industrial-scale production of e.g. soot, pigment-titanium dioxide and silicon dioxide particles.

Metal oxide nanoparticles have a host of applications including advanced anodes and cathodes for lithium-ion batteries.

Prior art presenting methods for their manufacturing is e.g. disclosed in US patent application 2013/0045158A1, U.S. Pat. No. 6,902,745, US patent application 20130273430, and U.S. Pat. No. 6,475,673B1.

An article by Ting-Feng Yi, Shuang-Yuan Yang and Ying Xie presents “Recent advances of Li₄Ti₅O₁₂ as a promising next generation anode material for high power lithium-ion batteries”. The article “Effect of Fuel Rate and Annealing Process of LifePO₄ Cathode Material for Li-ion Batteries synthetized by Flame Spray Pyrolysis Method is published by Abdul Halim, W. Widiyastuti, Heru Setyawan, Siti Machmudah, Tantular Nurtono, and Sugeng Winardi.

### SUMMARY

The method of the invention for combined production of nanomaterials and heat comprises the steps of feeding at least one precursor material and a fuel into a combustion unit for the generation of heat and nanoparticles, whereby the precursor material is combusted to be decomposed and oxidized in a sufficient temperature, recovering the heat generated in the combustion of the fuel and the precursor material using at least one heat exchanger, cooling down the combusted fuel, and collecting the nanoparticles generated in the form of oxides generated in the combustion.

The system of the invention for combined production of nanomaterials and heat comprises a combustion unit, means for feeding at least one precursor material, fuel and oxidizer into the combustion unit for combustion, a heat exchanger for recovering heat from the combustion unit and for cooling the combusted fuel, and means for collecting nanomaterials in the form of oxides from the combustion of the precursor material(s).

The preferable embodiments of the invention have the characteristics of the subclaims.

### The Combustion Process

Thus, the nanomaterial production of the invention takes place by combustion of gaseous or liquid fuels in power plants producing power and heat or only heat. The heat and power are generated in the process of the invention in a conventional way in the combustion unit, preferably in a power plant or in the heat plant, by heat exchangers.

Combustion, which is the scientific word for burning, is a chemical process in which a substance, which is called a fuel, reacts rapidly with oxygen and gives off heat through an energy transfer. The products of the combustion reaction are oxides and the source of oxygen is called the oxidizer.

During the combustion in general, new chemical substances are created from the fuel and the oxidizer. These substances are called exhaust. Most of the exhaust in a combustion unit that is a conventional power plant comes from chemical combinations of the fuel and oxygen. The temperature of the exhaust is high because of the heat that is transferred to the exhaust during combustion. Thus, during the combustion process, as the fuel and oxidizer are turned into exhaust products, heat is generated.

An important condition is that the precursor solution has to be brought into small droplets followed by evaporation/precursor decomposition, combustion, nucleation/condensation, aggregation, agglomeration, and powder collection.

Carbon can be used in the method for achieving advantageous properties for the end product to be prepared, e.g. to an LTO material. An incomplete combustion results in a layer of carbon on the nanoparticles which improves the functionality of Li-ion batteries.

To summarize, for combustion to occur three things must be present: a fuel to be burned, a source of oxygen, and a source of heat. A sufficient ignition temperature of the heat source is needed to start and continue the combustion process. As a result of combustion, exhausts are created, and heat is released. The combustion process can be controlled by the amount of the fuel available, the amount of oxygen available, or the source of heat.

### The Combustion Unit

Combustion units are commonly used for heat generation and heat transfer. The heat output of the combustion units can vary greatly.

In this text, the combustion units used are meant to cover all kinds of units for generation and transfer of only heat as well as all kind of units for generation of both heat and electricity.

The combustion unit used in the invention is especially either an industrial power plant, also referred to as a power station, for the generation of heat and electric power (or electricity) or an industrial heat plant for the generation of heat only.

For example, steam turbines can be used for the converting of heat directly into electrical energy.

One useful power plant used in the invention is a Combined Heat and Power (CHP) plant that generates electricity and captures the heat that would otherwise be wasted to provide useful thermal energy—such as steam or hot water—that can be used for space heating, cooling, domestic hot water and different industrial processes. Combined heat and power (CHP) production is the most efficient fuel-based energy production.

Most traditional power plants make energy by burning fuel to release heat. In combined heat and power generation, the energy content of the fuel is recovered and the part of the fuel's energy that cannot be converted to electricity is recovered as heat.

Most power stations in the world burn fossil fuels such as coal, oil, and natural gas to generate electricity and heat. Clean energy sources include nuclear power, and an increasing use of renewables such as solar, wind, wave, geothermal, and hydroelectric. Biomass-fired combined heat and power plants offer an alternative to environmentally damaging fossil fuels or intermittent renewables.

Power plants that produce both heat and power are usually based on steam superheating, wherein a heat recovery steam generator in the form of a boiler works as an energy recovery heat exchanger that recovers heat from a hot gas stream, such as a combustion or other waste gas stream. It produces steam that can be used in a process or used to drive a steam turbine.

If the process is producing only power with a condensing steam turbine, the heat exchanger from the steam turbine uses cooling water to condense the steam into water. An extraction turbine is used, if steam is needed for an industrial process. In combined heat and power plants, the waste heat produced in a plant facility is utilized in industrial processes to cover the heat demand of individual buildings or exported to a district heating system.

The combustion unit involves a burner in a boiler. The burner of a boiler causes burning the gas or liquid fuel in a controlled manner in the boiler. The burner is thus a part of the combustion unit in the form of a fuel-burning or heat-producing device, such as a boiler furnace or stove, where normally a flame or heat is produced.

The combustion temperature used should be sufficient to cause decomposition of the precursor materials, which can vary depending of precursor material, fuel, the amounts of these and some other reaction conditions, such as flow rates.

### The Precursor Material(s)

In some embodiments of the invention, said at least one precursor material is mixed and dissolved in the fuel in one or more separate containers before feeding them into the combustion unit. In that case, metal precursor materials are dissolved in liquid fuels, such as ethanol or methanol, and combusted directly in a combustion unit to produce heat and power and nanomaterials.

In other embodiments, said at least one precursor material and fuel are fed separately into the combustion unit, said at least one precursor material being fed by spraying in the form of droplets of a water solution of the precursor material. The precursor materials can in this case be injected separately as solid particles or liquid droplet into the gas burner flame, such as a hydrogen or methane flame, where the precursor material is decomposing at high temperature and forms nanoparticles when the flame is cooling down.

Examples of suitable metal precursors are sulphates, chlorides, nitrates, carbonates, and hydroxides of Lithium (Li), Titanium (Ti), Nickel (Ni), Manganese (Mn), Cobolt (Co), Aluminum (Al), Iron (Fe), Phosporus (P), Silver (Ag), Silicon (Si), Carbon (C), Niobium (Nb), Zinc (Zn), and Sulphur (S). Further, Titanium tetraisopropoxide (TTIP) is a useful organometallic precursor for Titanium metal oxide nanoparticles. TiCl₄ is an example of a gaseous precursor with a low evaporating temperature.

Typical Li-ion battery cathode (in LTO, NMC, LMO, or LFP-based batteries) and anode (in LTO-based batteries) precursors contain Li and other elements as inorganic forms because they are much cheaper than organometallic precursors. Lithium and other metals are typically in the form of nitrates, hydroxides, carbonates, sulphates, chlorides etc. The chlorides are, however, not preferable due to their corrosive effects in the boiler.

The precursors and fuels used in the method for nanoparticle production are especially selected to be suitable for both nanoparticle and energy production with respect to reactivity and solubility, also safety and costs taken into consideration.

### The Nanoparticle Products

The primary goal in the invention is to produce nanoparticles, which are metal oxides, such as different lithium oxides to be used in battery electrodes. Examples of metal oxide nanoparticles to be produced are
Lithium Titanate (Lithium-Titanium oxide, Li₂TiO₃, or Li₄Ti₅O₁₂, LTO) for producing an anode material for Lithium-ion batteries from Li₄Ti₅O₁₂ and for producing a cathode material for Lithium-ion batteries Li₂TiO₃ can be used in the cathode of some lithium-ion batteries, along with an aqueous binder and a conducting agent. The lithium-titanate-oxide (LTO) battery is a type of rechargeable battery
The formation of Li₄Ti₅O₁₂ is sensitive to the molar ratio of lithium and titanium in the precursor. Preferably, a stoichiometric ratio of Li/Ti (4:5) should be used. Excess lithium or titanium will result in the appearance of a second phase of rutile (TiO₂) or ordered Li₂TiO₃, respectively. The reaction is complete at high temperatures in a shorter time i.e. >800 C.
Lithium Nickel Manganese Cobalt Oxides. They have the general formula LiNiₓMn_{y}Co_{z}O₂. (such as LiNiMnCoO₂, and are abbreviated Li-NMC, LNMC, NMC, or NCM). They are mixed metal oxides for producing a cathode material for Lithium-ion batteries
Lithium Iron Phosphate for producing a cathode material for lithium iron phosphate batteries (lithium ferrophosphate LiFePO₄, LFP)
Lithium Manganese Oxide (LMO, the chemical formula including LiMn₂O₄, Li₂MnO₃, LiMnO₂, and Li₂MnO₂ and different composites) for producing a cathode material for lithium ion manganese oxide batteries (LMO)
Usually, stochiometric metal ratios for all these other oxides should be used, e.g. NMC622 with Ni/Mn/Co ratios of 6/2/2 and so forth. Several different levels of nickel in NMC are of commercial interest. The ratio between the three metals is indicated by three numbers. LiNi_{0.6}Mn_{0.2}Co_{0.2}O₂ is abbreviated to NMC622.

Especially, the nanomaterials produced in the invention is intended to be used for Lithium-ion batteries, especially lithium-titanate-oxide (LTO) batteries.

### The Fuel

The fuel can be a solid, liquid, or gas, although the fuel in this invention is usually a liquid or gas. Examples of suitable liquid fuels are ethanol, methanol, propanol, or any alcohol that does not contain any impurities that would affect the end product quality, and into which the precursor material can be dissolved. Examples of suitable gaseous fuels are hydrogen or methane or other gaseous fuels, like natural gas, liquefied natural gas (LNG), acetylene and propane.

When liquid fuels are used, the metal oxide precursor can be anything that dissolves in the fuel. In gaseous fuels, the precursor can consist of solid particles or liquid droplets that decompose and react into metal oxide nanoparticles in the high temperature flame. The combustion temperature depends on different factors, such as the reaction time and rate, the delay of the materials in the unit, and the materials themselves, the temperature needed is usually within 1000° C.-2500° C.

### The Oxidizer

The oxidizer, likewise, could be a solid, liquid, or gas, and is preferably air in this invention, or a gas or air enriched with oxygen, or pure oxygen gas O₂.

### Nanomaterial Collection

The nanoparticles produced are in the form of nanomaterials in the form of agglomerates, i.e small primary particles of a size of size 1-50 nm and attached together to agglomerates (preferably not sintered, in which case they are called aggregates.

The produced nanoparticles are collected as a powder by normal power plant flue gas cleaning systems, such as electrostatic precipitators (ESPs) or bag filters after the heat exchangers, where heat is recovered and flue gas is cooled to a suitable temperature (preferable below 200° C.) for flue gas cleaning systems. Also, other filtering equipment or a cyclone or a scrubber can be used for the collection.

### Advantages

The innovation is a technology for combined large-scale nanomaterial generation and energy production. In the method, nanoparticles are produced in combustion processes, where fuels impregnated with precursor material are fired primarily in a continuous process. In the process, heat exchangers are used as heat sinks for energy production in similarity to existing heat and power plants.

Conventionally, when liquid fuels are used to produce energy i.e. heat and power in power plants, then typically, the used liquid fossil fuels are heavy fuel oil and light fuel oil. These fuels are fossil based, have high carbon footprint and contain impurities like sulphur and metals. Thus, these fuels are not suitable for very high purity material production. Bio-ethanol and -methanol, in the contrary, have low carbon footprints and do not contain harmful impurities, making them suitable for high purity nanomaterial production.

In the invention, the fuels considered are preferably renewable low carbon footprint sources such as ethanol or methanol produced from biomass feedstocks and green hydrogen produced e.g. by wind energy. Generally, green hydrogen is hydrogen fuel that is created using renewable energy instead of fossil fuels. It has the potential to provide clean power for manufacturing, transportation, and more—and its only byproduct is or exhaust is water.

A conventional production of LTO particles involves synthesis methods, which are focused on the quality, usability and properties of the end product as their use as an anode or cathode material of Li ion batteries.

The method of the invention is innovative and among its advantages, a considerable heat recovery is achieved to be utilized. The method of the invention combines the production of nanoparticles and energy to be a part of a conventional power and heat plant in an industrial scale. In this way, big amounts of nanoparticles can be produced.

A further aspect and advantage with the invention is that the heat exchanges used also cools down the exhaust gas at the same time as it provides heat, whereafter the nanoparticles can be collected with conventional filter bags and electrostatic filters normally used t power plants. In practice, the conventional filter bags and electrostatic filters do not stand very high temperatures, and therefore, the exhaust gas is cooled down already before these. In typical nanoparticle production, the exhaust gas is cooled down with air.

In the way of the invention, large amounts of nanomaterial are produced (1000-100000 t/y or even more depending on the plant size) by utilizing conventional power plants and fuels, such as renewable green fuels.

In the following, the invention is described by means of two embodiments to the details of which the invention is not restricted.

### FIGURES

FIG. 1 is a schematic view of a first embodiment of the invention for producing heat and metal oxide nanoparticles

FIG. 2 is a schematic view of a second embodiment of the invention for producing heat and metal oxide nanoparticles

### DETAILED DESCRIPTION

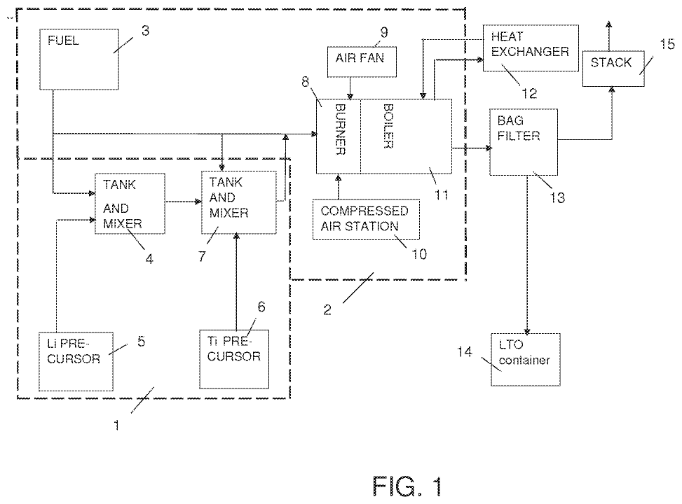

FIG. 1 is a schematic view of a first embodiment of the invention for producing heat and metal oxide nanoparticles.

As a whole, reference number 1, marked with dotted lines, represents the precursor material input needs for the nanoparticle production part of the invention, which optionally can be placed in a separated space or container, whereas reference number 2, also marked with dotted lines, represents the input needs of the heat generation part of the invention, which optionally can be in another separated space or container.

A fuel, which in the embodiment of FIG. 1, consists of liquid ethanol, is fed from a fuel tank 3 into a buffer tank 4 having a mixer.

A precursor material, which in this embodiment is assumed to be solid Lithium nitrate (LiNO₃), is fed from a (LiNO₃) powder storage 5 into the buffer tank 4 to be dissolved in the ethanol, where it forms a stable solution without solid precipitation.

Then a liquid Titanium tetraisopropoxide (TTIP) precursor is mixed with the ethanol and lithium nitrate solution just before entering a burner 8. For this reason, it is practical to first feed the ethanol and lithium nitrate solution to another tank with a mixer 7, before adding the Titanium tetraisopropoxide (TTIP) precursor from a storage 6 into it in said tank with the mixer 7, which e.g. can be a static pipe mixer or a tank with a mixer. It is important for the burner operation that all precursors are fully dissolved and stay in the solution and no precipitates are formed.

Other embodiments of the invention might use only one precursor material, whereby the tank and mixer 7 is not necessary or then more than one precursor materials might be fed into the same buffer tank 4.

In addition, AgNO₃ can be dissolved in the precursor solution and fed into the burner with the LiNO₃ and TTIP to enhance the performance of the LTO nanomaterial in the battery to be produced.

The AgNO₃ can also be added before adding the TTIP, whereby it can be mixed into the ethanol in the same buffer tank, wherein LiNO₃ is added into the ethanol.

The ethanol-LiNO₃-TTIP solution is then fed into a combustion unit having a burner 8, wherein the ethanol-LiNO₃-TTIP precursor material is combusted.

The flame temperature that is provided in the burner 8 by means of ignition gas is typically nearly 2000° C., usually 1800-2100° C., resulting in the decomposition of the LiNO₃ and TTIP and formation of metallic Li and Ti in an oxidising environment. Li, Ti and oxygen will then react to form Li₄Ti₅O₁₂ (LTO). The formation of Li₄Ti₅O₁₂ is sensitive to the molar ratio of lithium and titanium in the precursor. For example, a stoichiometric ratio of Li/Ti, i.e. 4:5, could be used. The firmed Li₄Ti₅O₁₂ can be used directly as an anode material in Li-ion batteries.

Another Lithium-Titanium oxide, Li₂TiO₃, LTO) for producing a cathode material for Lithium-ion batteries Li₂TiO₃ can be formed by changing the Li/ti ratio in the fed precursor solution.

The oxidizing environment is achieved by feeding air with e.g. an air fan 9 thus oxidizing the precursor materials and the ethanol to produce heat. Instead of air, a gas containing more oxygen than air can be used, even pure oxygen gas O₂. The heat is mainly a result of the combustion of the fuel but partly from the chemical reaction and decomposition of the precursor materials. In this case the decomposition/reactions LiNO₃ consumes heat and the decomposition/reactions of TTIP produces heat.

In the burner 8, compressed air 10 is used to disperse the ethanol fuel-(Li, Ti) precursor mixture into small droplets (mist, droplets preferable below 100 μm). A part of the air is usually consumed by the oxidation reaction of the precursor materials. The burner is a liquid fuel burner, by means of which the mixture of air and fuel/precursor droplets is ignited to burn at a high temperature to decompose the precursors into Li/Ti oxides and the ethanol fuel forms CO₂ and H₂O.

There is a boiler 11 in the combustion unit in connection with the burner 8, which boiler 11 consists of a furnace in which the fuel and precursor mixture is burned, and further, the boiler 11 consists of heat surfaces (not shown) to transmit heat from the combustion products as recovered by a heat exchanger 12 is used to recover the heat and cool the flue gas resulting from the combustion.

In this example, only heat is produced but the invention can also be used in connection with a power plant that produce both heat and power, for example by means of steam superheating, wherein a heat recovery steam generator works as a boiler, i.e. as an energy recovery heat exchanger that recovers heat from the hot gas stream being the result of the combustion. It produces steam that can be used to drive a steam turbine or is used as process steam in industrial processes.

Thus, in this embodiment, a heating plant, which typically is used to produce heat, has been expanded to produce LTO nanomaterial simply by dissolving its precursors in ethanol. Now both heat as well as LTO nanoparticles are produced in this power plant to give additional value for the heat production.

For the high electrochemical performance of the LTO in Li-ion batteries at high charge and discharge rates, it is important that it is composed of nanosized LTO primary particles, preferably with a size of 30-50 nm, to achieve short electronic and ionic conduction pathways. Ag nanoparticles with a size of 1-3 nm on the surface of the LTO particles (30-50 nm) will further enhance the electronic and ionic conductivity of the LTO particles, which improves the LTO nanomaterial performance in Li-ion batteries.

The produced LTO nanoparticles are filtered by a filtering unit 13 such as with normal bag house filters that are typically used in power plants for fuel gas cleaning and collected in a LTO container 14. The cleaned exhaust gas is led out to air through a stack 15.

Also, an electrostatic filter could be used. Thanks to the heat exchanger, which is situated before the filtering unit, the exhaust gas has been cooled down thus enabling collecting of the nanoparticles.

This is an inventive and advantageous part of the invention compared to prior art, wherein exhaust gases in power plants are cooled down by e.g. air, wherein the price for the filter bag is many times higher since it has to be dimensioned for a very big amount of gas.

Thus, the heat exchanger(s) used in the invention has two functions. In addition to heat recovery, it cools down the exhaust gas to a suitable temperature (preferable below) 200° ° C. for flue gas cleaning systems.

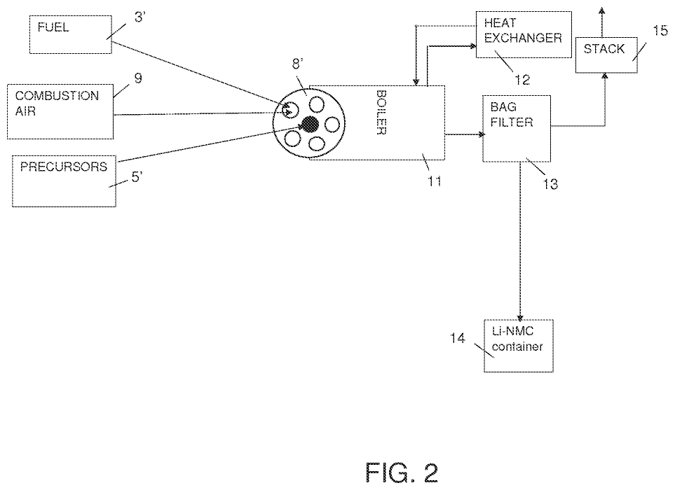

FIG. 2 is an architecture view of a second embodiment of the invention for producing heat and metal oxide nanoparticles.

In this example the fuel used is Hydrogen (H₂) gas, which is led from storage 3′ to be burned by e.g. a ring burner 8′, where several individual burner heads form a ring. Any gas burner, however, could be used for producing a controlled flame by mixing the fuel gas, here hydrogen, with an oxidizer such as the ambient air or supplied oxygen, and allowing for ignition and combustion.

Droplets of a water solution of e.g. inorganic sulphates of different metals, such as Li₂SO₄, NiSO₄, MnSO₄, and CoSO₄ are sprayed into the middle of the burner ring from storages 5′ (not distinguished in the figure). Instead of or in addition to Li₂SO₄, a useful Li-precursor is LiNO₃. The droplet size can be of the order of 10-100 micrometers.

The oxidizing environment is achieved by feeding the hydrogen gas together with combustion air from a storage 9 thus oxidizing the precursor materials and the hydrogen to produce heat.
(a) The inorganic metal precursors decompose completely in the burner flame achieved by means of ignition gas and then they react and form the desired Li—Ni—Mn—Co—O final product consisting of different oxides of the metals, i.e. Li, Ni, Mn, and Co. They have the general formula LiNiₓMn_{y}Co_{z}O₂. (such as LiNiMnCoO₂, and are abbreviated Li-NMC, LNMC, NMC, or NCM). The fractions of the metals can be varied by changing their concentrations in the water solution precursor.
(b) The temperature profile of the particle formation can be varied by modifying the fuel-to-precursor feed rate ratio. Thus, it is possible to achieve conditions where the inorganic metal precursors do not vaporize but react in the droplet phase to form the desired final LiNiₓMn_{y}Co₂O₂ product. The fractions of the metals can be varied by changing their concentrations in the water solution precursor. In this case the final product is composed of larger particles.

As in the embodiment of FIG. 1, there is a boiler 11 in the combustion unit in connection with the burner 8′, which boiler 11 consists of a furnace in which the fuel and precursor mixture is burned, and further, the boiler 11 consists of heat surfaces (not shown) to transmit heat from the combustion products as recovered by a heat exchanger 12 is used to recover the heat resulting from the combustion.

The produced Li-NMC particles are collected by normal bag house filters 13 that are typically used in power plants for flue gas cleaning and collected in a Li-NMC container 14. The cleaned exhaust gas is led out to air through a stack 15.

As in the embodiment of FIG. 1, also here only heat is produced but also electricity could be produced.

Thus, in this embodiment a heating plant has been expanded to produce Li-NMC material simply by dissolving its precursors in water and spraying the solution into the gas flame, which is typically used to produce heat without metal precursors. Now both heat and Li-NMC particles are produced in this power plant to give added value for the heat production.

### EXAMPLES

### Example 1

In a process in accordance with FIG. 1, for example in a 10 MW (fuel power) plant, lithium and titanium precursors can be fed in a stoichiometric ratio (up to 2 moles/litre solution in liquid fuel (e.g. ethanol) to produce LTO nanomaterial.

A solution of 51 kg/h LiNO₃, 280 l/h TTIP and 1 400 l/h ethanol was combusted to produce 71 kg/h LTO nanomaterial. Silver doping of the particles was achieved by adding AgNO₃ to the precursors.

LTO material with a primary particle size of 20 nm measured by transmission electron microscope (TEM) and Brunauer-Emmett-Teller (BET) was produced in a laboratory scale burner. The specific surface area SSA of the formed nanoparticles was 87 m²/g and the silver (Ag) concentration was 1 wt % measured by Inductive coupled mass spectrometer (ICP-MS).

### Example 2

In a process in accordance with FIG. 2, for example in a 10 MW (fuel power) gas fired power up to 2 moles/litre water solution of Li, Ni, Mn and Co precursors can be sprayed as small droplets (droplet size below 100 μm) to produce NMC li-ion battery cathode material plant,

Accordingly, 59 kg/h LiNO₃, 79 kg/h NiSO₄, 26 kg/h MnSO₄ and 27 kg/h CoSO₄ in water solution are fed to produce 83 kg/h NMC622 material.

### Example 3

Lithium titanate (LTO) production in a traditional Light Fuel Oil burner (LFO) burner was tested. A commercial LFO burner was converted to an ethanol burner according to the manufacturer's recommendations.

A fuel mixture of 49 g/h of Li-nitrate and 260 ml/h of Ti-tetraisopropoxide in 1.3 l/h of ethanol was burned in the modified LFO burner to produce 83 g/h of LTO powder.

A collected powder sample was analyzed by using Scanning Electron Microscopy (SEM) and Energy Dispersive X-ray Spectroscopy (EDS) for morphology and chemical composition, an organic carbon and elemental carbon (OC/EC) analyser to determine the elemental carbon (soot) and organic carbon content as well as X-ray powder diffraction (XRD) to analyse the LTO crystal phase.

The production rate was calculated to be 0.5 g/h with a collection efficiency of 60%.

As can be seen from this, some particles were lost in the heat exchanger and flue gas lines. The total carbon content of the product was 1.24% of which the organic carbon content was 1.07% and soot 0.15%. The XRD showed that crystalline lithium titanate particles were produced.

1. Method for combined production of nanomaterials and heat, the method comprising the steps of
a) feeding at least one precursor material and a fuel into a combustion unit (11) for the generation of heat and nanoparticles, whereby the precursor material is combusted to be decomposed and oxidized in a sufficient temperature,
b) recovering the heat generated in the combustion of the fuel and the precursor material using at least one heat exchanger (12),
c) cooling down the combusted fuel, and
d) collecting the nanoparticles generated in the form of oxides generated in the combustion.

2. Method of claim 1, wherein step a) is preceded by dissolving said at least one precursor material in the fuel in one or more separate containers (4, 7) or mixers before feeding them into the combustion unit (11).

3. Method of claim 1 or 2, wherein compressed air is fed to the combustion unit (11) for dispersion a mixture of precursor material and liquid fuel into small droplets.

4. Method of any of claims 1-3, wherein Silver nitrate (AgNO₃) is dissolved in a solution of the precursor material to be fed into the combustion unit (11).

5. Method of claim 1, wherein said at least one precursor material and fuel are fed separately into the combustion unit (11).

6. Method of claim 5, wherein said fuel is a liquid fuel and said at least one precursor material is fed by spraying in the form of droplets of a solution of the precursor material.

7. Method of claim 5, wherein said fuel is a gaseous and said at least one precursor material is fed in the form of droplets of a solution of the precursor material or suspended in a gas as solid particles.

8. Method of any of claims 1-7, wherein said at least one precursor material is selected from sulphates, chlorides, nitrates, carbonates, and hydroxides of Lithium (Li), Titanum (Ti), Nickel (Ni), Manganese (Mn), Cobolt (Co), Aluminum (Al), Iron (Fe), Phosporus (P), Silver (Ag), Silicon (Si), Carbon (C), Niobium (Nb), Zinc (Zn), and Sulphur (S), and Titanium tetraisopropoxide (TTIP).

9. Method of any of claims 1-8, wherein the fuel is ethanol, methanol, propanol, natural gas, liquefied natural gas, LNG, or hydrogen, acetylene, methane, or propane.

10. Method of any of claims 1-9, wherein the oxidizing of the precursor material is performed by feeding an oxidizer into the combustion unit (11), such as air, a gas containing more oxygen than air, or pure oxygen gas (O₂).

11. Method of any of claims 1-10, wherein the nanoparticles generated in the form of oxides from the combustion of the precursor material(s) consist of Lithium-Titanium oxide, Li₂TiO₃ or Li₄Ti₅O₁₂, LTO), Lithium Nickel Manganese Cobalt Oxides (LiNiₓMn_{y}Co_{z}O₂, Li-NMC), Lithium Iron Phosphate (LiFePO₄, LFP), Lithium Manganese Oxide (LMO, LiMn₂O₄, Li₂MnO₃, LiMnO₂, and/or Li₂MnO₂, and/or different composites, (LMO).

12. Method of claim 11, wherein a stoichiometric ratio of Lithium/Titanium of 4:5 is used in the precursor feed for forming Li₄Ti₅O₁₂.

13. Method of claim 12, wherein nanosized LTO articles of Li₄Ti₅O₁₂ with a size of 30-50 nm is produced optionally together with Ag nanoparticles with a size of 1-3 nm on the surface of the LTO particles.

14. Method of any of claims 1-11, wherein the combustion temperature used is sufficient to cause decomposition and reaction of the precursor materials, such as 1000-2500° C.

15. Method of any of claims 1-14, wherein a layer of carbon is provided on the nanoparticles by means of an incomplete combustion.

16. Method of any of claims 1-15, wherein at least part of the recovered heat is utilized for other industrial processes or for warming of buildings.

17. Method of any of claims 1-16 wherein at least part of the recovered heat is converted to electricity, preferably by means of a steam generator.

18. System for combined production of nanomaterials and heat comprising
a) a combustion unit (11),
b) means for feeding at least one precursor material, fuel and oxidizer into the combustion unit for combustion,
c) a heat exchanger (12) for recovering heat from the combustion unit (11), and for cooling the combusted fuel,
d) means (13) for collecting nanomaterials in the form of oxides from the combustion of the precursor material(s).

19. System of claim 18, wherein the combustion unit (11) is an industrial heat plant, wherein heat is generated and utilized for other industrial processes or for warming of buildings.

20. System of claim 18, wherein the combustion unit (11) is an industrial power plant, wherein heat and electricity are produced.

21. System of claim 20, wherein the industrial power plant is a Combined Heat and Power, CHP, plant.

22. System of any of claims 18-21, wherein the combustion unit (11) comprises a burner (8) for liquid fuel.

23. System of any of claims 18-21, wherein the combustion unit (11) comprises a burner (8) for gaseous fuel, such as a ring burner (8′), where several individual burner heads form a ring.

24. System of any of claims 18-23, wherein the means (13) for collecting the nanomaterials is a bag filter (13) or an electrostatic precipitator or other filtering equipment or a cyclone or a scrubber.
